(19) United States
(12) Patent Application Publication
(10) Pub. No.: US 2004/0179721 A1
(43) Pub. Date: Sep. 16, 2004

(54) Image apparatus and face authentication apparatus

(76) Inventor: Junichi Nishimura, Shiga (JP)

Correspondence Address: DICKSTEIN SHAPIRO MORIN & OSHINSKY LLP, 2101 L STREET NW, WASHINGTON, DC, 20037-1526, US

(21) Appl. No.: 10/798,950

(22) Filed: Mar. 12, 2004

(30) Foreign Application Priority Data
Mar. 12, 2003 (JP) 2003-066282

(51) Int. Cl. G06K 9/00

(52) U.S. Cl. 382/118

(57) ABSTRACT

A face authentication apparatus is provided to be able to preferentially cause a subject person to look somewhat downward at the time of imaging. An image lens of a camera is made hard to be seen by a subject person and a dummy lens that can be clearly seen by the subject person is arranged below the image lens, to cause the person subject to authentication to think that the dummy lens is an image lens of a camera. Thereby, a line of sight of the subject person can be drawn downward at the time of imaging, so that it is possible to obtain an imaged picture of a somewhat downwardly directed person's face being an object, that is, an imaged picture, on which an influence caused by reflection of a lighting illuminating the subject person is small.

### BACKGROUND OF THE INVENTION

1. Field of the Invention

The present invention relates to an image apparatus that uses a camera to image a face picture of a subject person, and more particularly, to a face authentication apparatus that processes a face picture, as imaged, of a subject person, and authenticates whether the subject person is a registrant.

2. Description of the Related Art

Conventionally, there have been face authentication apparatuses that process a face picture, as imaged by a camera, of a subject person, and authenticate whether the subject person is a registrant. The face authentication apparatus stores, for every registrant, face picture data representative of feature criteria of a face part such as eyes, nose, mouth, contour, etc. The face authentication apparatus extracts feature criteria of a face part from a face picture, imaged by a camera, of a subject person, and creates face picture data of the subject person from the extracted feature criteria of the face part. And, the face authentication apparatus collates the face picture data as created and face picture data of registrants as stored with each other, and when there is present a registrant whose degree of similarity is larger than a predetermined threshold, the subject person is determined to be a registrant. On the other hand, when there is present no registrant whose degree of similarity is larger than the predetermined threshold, the subject person is determined not to be a registrant (an unregistered person). Such face authentication apparatuses include a type that collates face picture data of a subject person with all registrants and authenticates whether the subject person is a registrant, and another type that causes a subject person to input an identification number, collates face picture data of the subject person with a registrant who is identified by the input identification number and authenticates whether the subject person is a registrant.

Face authentication apparatuses are made use of in, for example, an entrance and exit management system that restricts persons who enter a room.

Also, there exist authentication apparatuses that authenticate whether a subject person is a registrant on the basis of biological information of a separate kind, for example, feature criteria of iris, fingerprint, and voiceprint instead of feature criteria of a face part.

For example, Japanese patent document JP-A-2000-132681 describes an authentication apparatus that processes imaged pictures of eyes of a subject person, acquires iris data being feature criteria of irises of the subject person, collates the iris data as acquired with iris data of registrants stored in a memory, and authenticates whether the subject person is a registrant.

Also, Japanese patent document JP-A-2000-132681 describes that in order to acquire imaged pictures of eyes, with eyelids fully opened, an illuminant provided in a position at a higher level than that of the eyes of the subject person is caused to emit light at the time of imaging the person with a line of sight of the person drawn upward. That is, the Japanese patent document JP-A-2000-132681 describes that in order to open their eyelids, the person is caused to look upward.

It has been found in face authentication apparatuses that an imaged picture directed somewhat downward is suited to authentication rather than an imaged picture taken from directly opposite a subject person since reflected light from a person at the time of imaging, in particular, reflected light from glasses worn by the person, has less influence on imaging. For example, in the case of an imaged picture imaged from directly opposite a subject person, eyes and their periphery are not adequately imaged due to reflected light from glasses worn by the person. Hereupon, in contrast to the authentication apparatus described in Japanese patent document JP-A-2000-132681, conventional face authentication apparatuses cause an illuminant such as an LED or the like disposed below a camera to emit light at the time of imaging in order to draw downward a line of sight of a person being authenticated.

Since most persons being authenticated think that when a posture is poor at the time of imaging, an inappropriate authentication is performed (the probability that a registrant is erroneously authenticated to be an unregistered person is high), however, they will look at an image lens instead of an illuminant that emits light below a camera (image lens) at the time of imaging. Therefore, an imaged picture of a subject person is in many cases imaged from directly opposite the person, so that the purpose of obtaining a somewhat downward imaged picture of the person cannot be adequately attained in a configuration in which an illuminant such as an LED or the like disposed below a camera is caused to emit light.

In addition, even with the authentication apparatus described in Japanese patent document JP-A-2000-132681, there are likewise plenty of persons subject to authentication who see an image lens without seeing an illuminant that emits light at the time of imaging, so that the purpose of obtaining an imaged picture of eyes, with eyelids fully opened, of a person being authenticated cannot be adequately attained.

### BRIEF SUMMARY OF THE INVENTION

It is an object of the invention to provide an image apparatus that addresses the fact that a subject person looks at an image lens at the time of imaging, makes the image lens hard to be seen by the subject person, and arranges a dummy lens of no consequence to imaging on a side toward which the subject person is desired to face, relative to the image lens, so that the dummy lens is clearly seen by the subject person, whereby the subject person is caused to face in a desired direction.

Also, it is an object of the invention to provide a face authentication apparatus that can preferentially cause a subject person to face somewhat downward, by arranging the dummy lens below the image lens.

The image apparatus according to the invention is constituted in the following manner:

The image apparatus is accommodated in a body or housing and provided with a camera that images a subject person, the image apparatus comprising a shielding member arranged in front of an image lens of the camera accommodated in the housing, and a dummy lens arranged in the periphery of the image lens and in a position that can be seen by the subject person.

With such constitution, a camera that images a subject person is accommodated in a body, and a shielding member such as smoked glass and color filters is arranged in front of an image lens of the camera. Therefore, the image lens is difficult to be seen by the subject person.

In addition, the shielding member has a transmittance by which an image picture free from degradation with respect to accuracy of authentication is obtainable and suitable to be used in the processing of authentication images or the like.

A dummy lens is arranged in the periphery of the image lens and in a position that can be viewed by a subject person. Preferably, the dummy lens is arranged so that a subject person can clearly see it. For example, it suffices that the dummy lens is arranged on a body surface without being covered by a shielding member or the like.

Thereby, it is possible to cause a subject person to think that the dummy lens is an image lens. Since a subject person is liable to look at a lens of a camera at the time of imaging, selection of a position of a dummy lens relative to an image lens enables imaging such that a subject person is caused to face in a desired direction. For example, by arranging a dummy lens below an image lens, an imaged picture of a somewhat downwardly facing subject person is obtained. Also, by arranging a dummy lens above an image lens, an imaged picture of a somewhat upwardly facing subject person is obtained, and by arranging a dummy lens on a left side of an image lens, an imaged picture of a somewhat leftwardly facing subject person is obtained. By arranging a dummy lens on a right side of an image lens, an imaged picture of a somewhat rightwardly facing subject person is obtained.

The face authentication apparatus according to the invention is constituted in the following manner in order to solve the above problem.

The face authentication apparatus includes storage means that stores a face picture of every registrant, a camera that is accommodated in a body and images a face of a subject person, and authentication means that processes a face picture, imaged by the camera, of the subject person and authenticates whether the subject person is a registrant whose face picture is stored in the storage means. The face authentication apparatus includes a shielding member arranged in front of an image lens of the camera accommodated in the body, and a dummy lens arranged below the image lens and in a position that can be seen by the subject person.

With this constitution, the dummy lens is arranged below the image lens, so that it is possible to draw downward a line of sight of a subject person at the time of imaging and to obtain an imaged picture of a somewhat downwardly directed subject person, that is, an imaged picture on which an influence caused by reflection of lighting from the subject person at the time of imaging is small. Thereby, the accuracy of authentication in face determinations can be enhanced.

### BRIEF DESCRIPTION OF THE DRAWINGS

FIG. 1 is a block diagram showing a construction of a face authentication apparatus according to an embodiment of the invention;

FIG. 2 is a front view showing the face authentication apparatus according to an embodiment of the invention;

FIG. 3 is a cross sectional view showing an interior of the face authentication apparatus shown in FIG. 2;

FIG. 4 is a flowchart indicating an operation of the face authentication apparatus according to an embodiment of the invention; and

FIGS. 5A and 5B are views illustrating the relationship between the face authentication apparatus according to an embodiment of the invention and a person who is an object of authentication, and whose face is imaged.

### DETAILED DESCRIPTION OF THE INVENTION

A face authentication apparatus according to an embodiment of the invention will be described below.

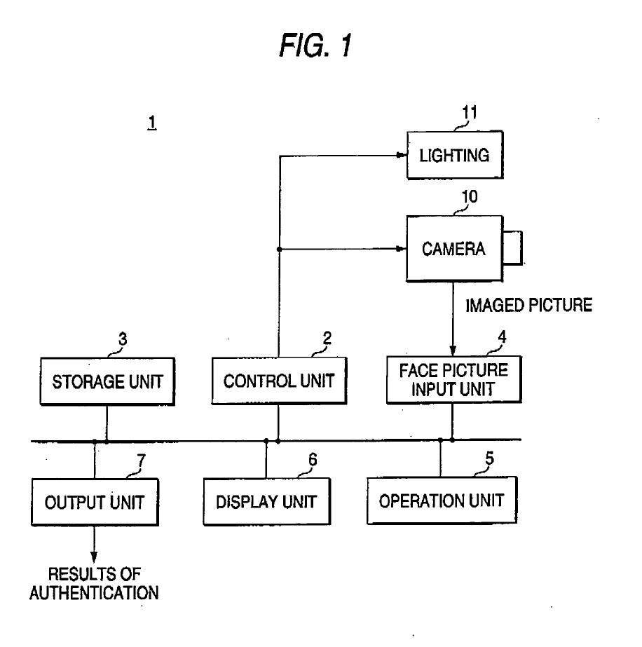

FIG. 1 is a block diagram showing a construction of a face authentication apparatus. The face authentication apparatus 1 according to the embodiment is one that processes a face image, obtained by a camera 10, of a person subject to authentication, and determines whether the subject person is a registrant. When a subject person is imaged by the camera 10, a light 11 illuminates the subject person. The face authentication apparatus 1 comprises a control unit 2 that controls an operation of a body, a storage unit 3 that stores feature criteria of a face of every registrant, a face picture input unit 4, into which an image obtained by the camera 10 is input, an operation unit 5 that performs an input operation on the body, a display unit 6 that displays an operating state of the body, results of authentication, etc., and an output unit 7 that outputs results of authentication. The control unit 2 includes a picture memory that temporarily stores an imaged picture of the camera 10 input into the face picture input unit 4, a RAM that stores data generated at the time of operation, a ROM, in which an operating program of the body is recorded, etc.

The storage unit 3 assigns to every registrant an identification code that identifies a registrant, and stores face picture data representative of feature criteria of a face part such as eyes, nose, mouth, contour, etc.

The control unit 2 processes a face picture, imaged by the camera 10 and input into the face picture input unit 4, of a subject person, acquires feature criteria of a face part such as eyes, nose, mouth, contour, etc., and creates, on the basis of the feature criteria of a face part, face picture data of the subject person. The control unit collates the created face picture data and face picture data of respective registrants with each other, and calculates the degree of similarity therefor. Here, when a maximum value of the calculated degree of similarity is larger than a predetermined threshold, the subject person is authenticated to be a registrant having the maximum degree of similarity. On the other hand, when a maximum value of the degree of similarity is smaller than the predetermined threshold, the subject person is determined not to be a registrant (unregistered person).

In addition, the control unit 2 instructs the camera 10 to image a subject person and instructs the light 11 to light up.

The output unit 7 outputs results of authentication of a subject person. Results of authentication output from the output unit 7 are input into, for example, an apparatus that controls locking and unlocking of a door. The apparatus locks and unlocks a door on the basis of the input results of authentication.

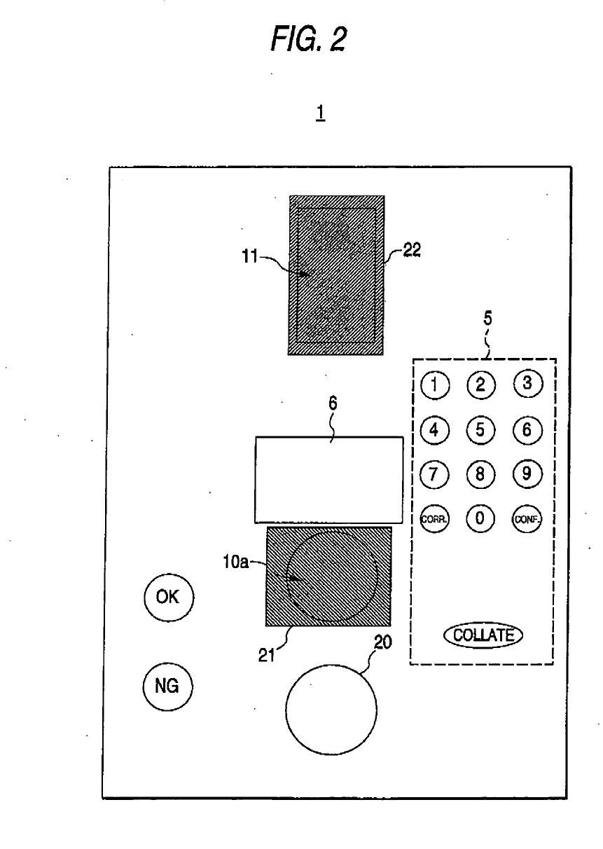

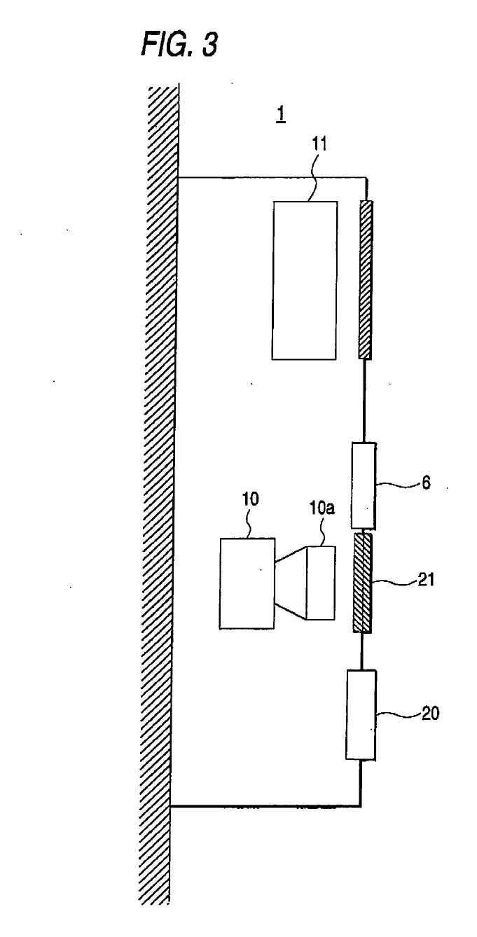

FIG. 2 is a front view showing the face authentication apparatus according to an embodiment of the invention, and FIG. 3 is a cross sectional view showing an interior of the face authentication apparatus of FIG. 2. Illustration of a control unit, etc., accommodated in the interior of the body is omitted in FIG. 3 for simplicity.

The face authentication apparatus 1 shown in FIGS. 2 and 3 is mounted on a wall surface or the like. Arranged on a right side of a body surface are a ten key, collate key pad operated at the time of authentication, etc. The light 11, the display unit 6, the camera 10, and a dummy lens 20 are aligned in this order from the top down in a central portion of the body. Also, arranged on a left side of the body are an indicating lamp (an indicating lamp (OK lamp) that lights up when it is determined that a subject person being an object of authentication is a registrant) indicative of results of authentication, and an indicating lamp (NG lamp) that lights up when it is determined that a subject person is not a registrant. The light 11 is accommodated in the body, and has a shielding member 22 provided on its front surface to adjust a quantity of light irradiated on a subject person at the time of imaging.

Also, the camera 10 is accommodated in the body. A shielding member 21 such as smoked glass and color filters is arranged in front of an image lens 10a of the camera 10. Therefore, the image lens 10a is hard to see for a subject person, the person being disposed in front of the body. The shielding member 21 has a transmittance by which an image picture free from degradation in accuracy of authentication is obtainable, suitable for use in the processing of authentication images.

Further, the dummy lens 20 is exposed on the surface of the body. Also, unlike the image lens 10a, the front surface of the dummy lens is not covered by any shielding member and the dummy lens is disposed so that a subject person disposed directly opposite to the body can visually confirm the dummy lens. In other words, the dummy lens 20 is disposed so that a subject person located directly opposite to the body can see it clearly.

In addition, as apparent from the above explanation, the dummy lens 20 is disposed below the image lens 10a. Also, the dummy lens 20 does not contribute to imaging of a subject person.

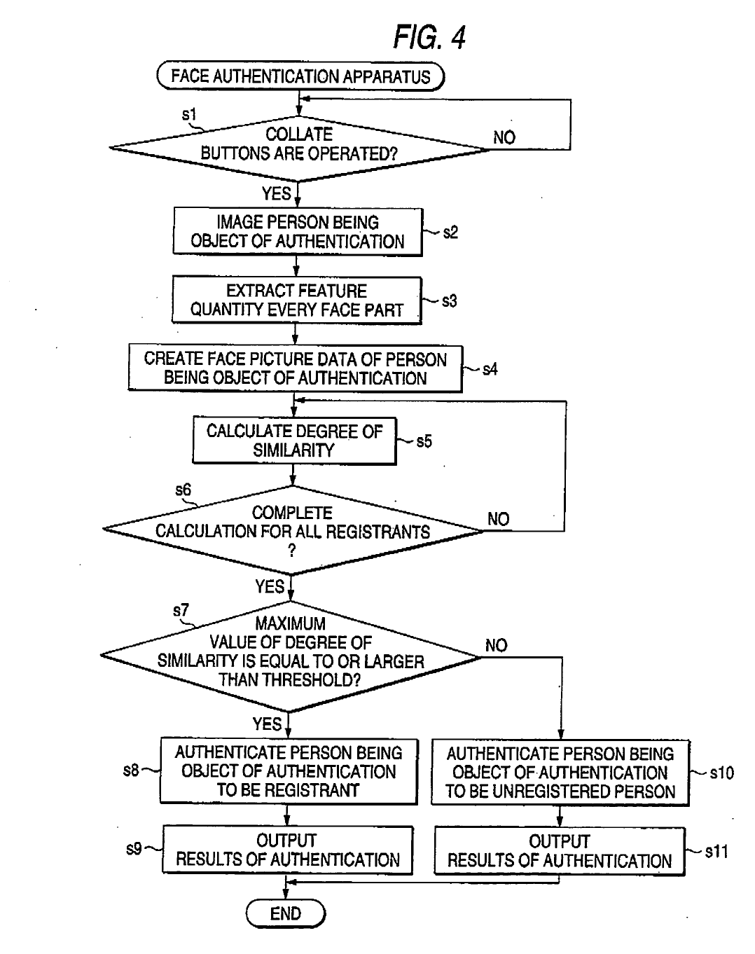

An operation of the face authentication apparatus 1 according to an embodiment of the invention is now described. FIG. 4 is a flowchart indicating an operation of the face authentication apparatus according to the embodiment. The face authentication apparatus 1 waits for a subject person to operate collate buttons provided in the operation unit 5 (s1). A person subject to authentication stands facing the front part of the face authentication apparatus 1 and operates the collate buttons when the face authentication apparatus 1 is required to authenticate that the person is a registrant, for example, when the person enters a room, entrance into which is restricted, in an entrance and exit management system, to which the face authentication apparatus 1 is applied.

The dummy lens 20 is mounted at a level of about 140 to 150 cm, which is lower than average eye level for a common subject person. The image lens 10a of the camera 10 is mounted at a level about 10 cm above the dummy lens 20, at which a whole face of a subject person can be imaged. The image lens 10a is at eye level of a common subject person.

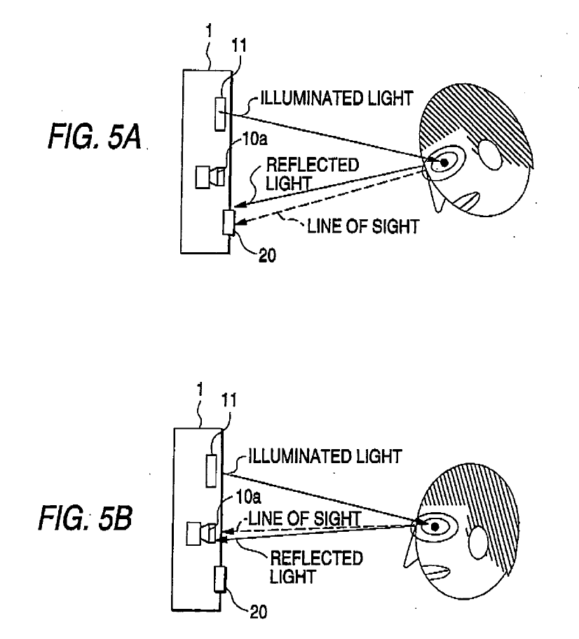

A subject person operates the collate buttons and simultaneously the face authentication apparatus 1 obtains an image of the subject person with the use of the camera 10. The person being subjected to authentication thinks that the dummy lens 20 is an image lens of the camera 10, and looks at the dummy lens 20 when imaging is performed. When the subject person is imaged in the step s2, the light 11 is lighted up. As described above, since the dummy lens 20 is mounted at a level lower than that of the eyes of the subject person, a line of sight of the person is directed somewhat downward (see FIG. 5A). Accordingly, a face picture, imaged by the camera 10, of the subject person is not an imaged picture taken directly in front but is an imaged picture directed somewhat downward. Therefore, even in the case where the subject person wears glasses, an imaged picture is obtained having less influence caused by reflected light from the glasses. In other words, regularly reflected light from glasses worn by a subject person can be prevented from providing an imaged picture in which eyes and their periphery are not adequately imaged, and so it is possible to obtain an imaged picture suited to authentication of a subject person.

In addition, for the purpose of comparison, FIG. 5B shows a situation in which a subject person sees the image lens 10a. In this case, a face picture, imaged by the camera 10, of the subject person is an imaged picture taken from directly in front of the camera.

The face authentication apparatus 1 extracts feature criteria for every face part from a face picture, imaged in the step s2, of a subject person (s3), and creates face picture data of the subject person (s4). The face picture data, created in the step s4, of the subject person is of the same type as that of a registrant stored in the storage unit 3.

The face authentication apparatus 1 calculates the degree of similarity with respect to the face picture data, created in the step s4, of the subject person and all registrants for which face picture data are stored in the storage unit 3 (s5, s6). The face authentication apparatus collates face picture data stored for every registrant in the storage unit 3 with the face picture data, created in the step s4, of the subject person, and calculates the degree of similarity therefor.

When calculation of the degree of similarity for all registrants is completed, the face authentication apparatus 1 judges whether a maximum value of the degree of similarity as calculated is equal to or larger than a threshold (s7). The threshold is predetermined.

In addition, when the threshold is made small, the probability that an unregistered person is erroneously authenticated to be a registrant is increased, and on the other hand, when the threshold is made large, the probability that a registrant is erroneously authenticated to be an unregistered person is increased. The threshold is adjusted according to the level of security. The higher the level of security, the larger the threshold.

When a maximum value of the degree of similarity as calculated is found in the step s7 to be equal to or larger than the threshold, the face authentication apparatus 1 determines the subject person to be a registrant (a registrant, for which the degree of similarity becomes maximum) (s8), and outputs results of the determination from the output unit 7 (s9). On the other hand, when a maximum value of the degree of similarity as calculated in the step s7 is smaller than the threshold, the face authentication apparatus determines the subject person to be an unregistered person (s10), and outputs results of the determination from the output unit 7 (s41).

Also, the face authentication apparatus 1 displays results of the authentication on the body. When the subject person is determined to be a registrant, the OK lamp is lighted, and on the other hand, when the person being an object of authentication is authenticated to be an unregistered person, the NG lamp is lighted.

Results of the authentication output from the output unit 7 are input into, for example, an apparatus that locks and unlocks a door. According to results of the authentication, the apparatus locks and unlocks a key of the door.

In this manner, the face authentication apparatus 1 according to the embodiment can cause a subject person to think that the dummy lens 20 is an image lens. The dummy lens 20 can be visually confirmed by the subject person and is disposed below the image lens of the camera 10. The image lens 10a is difficult to see for the subject person. Since a subject person is liable to look at an image lens of a camera at the time of imaging, a line of sight of the subject person can be drawn downward, and a somewhat downwardly directed face can be imaged. Therefore, even in the case where a subject person wears glasses, an imaged picture is obtained in which an influence caused by reflected light from the glasses is restricted. In other words, since regularly reflected light from glasses worn by a subject person can be prevented from providing an imaged picture, in which eyes and their periphery are not adequately imaged, it is possible to obtain an imaged picture suited to authentication of a subject person, whereby the accuracy of authentication can be enhanced.

Also, since there is no need for causing an illuminant such as LEDs or the like to emit light in order to draw a line of sight of a subject person as in the conventional art, the body can be simplified in operation and so reduced in cost.

In addition, while the degree of similarity is calculated for all registrants in the above embodiment, the degree of similarity associated with a registrant who can be identified by an identification number input by a subject person may be calculated.

Also, while according to the embodiment the dummy lens 20 is arranged below the image lens 10a of the camera 10 in order to image a somewhat downwardly directed face of a subject person, when a somewhat upwardly directed face of a subject person is to be imaged, it suffices that the dummy lens 20 is arranged above the image lens 10a of the camera 10. Also, when a somewhat rightvardly directed face of a subject person is to be imaged, it suffices that the dummy lens 20 is arranged on a right side of the image lens 10a of the camera 10, and when a somewhat leftwardly directed face of a subject person is to be imaged, it suffices that the dummy lens 20 is arranged on a left side of the image lens 10a of the camera 10.

As described above, since it is possible according to the invention to cause a subject person to think that a dummy lens arranged around an image lens of a camera is an image lens, selection of the position of the dummy lens relative to the image lens can cause a subject person to look in a desired direction at the time of imaging.

Also, since the dummy lens is arranged below the image lens and a line of sight of a subject person is drawn downward at the time of imaging, it is possible to obtain an imaged picture of a somewhat downwardly directed subject person, that is, an imaged picture, on which an influence caused by reflection of light illuminating a subject person is small. Thereby, the accuracy of face authentication can be enhanced.

What is claimed as new and desired to be protected by Letters Patent of the United States is:

1. An image apparatus accommodated in a body and provided with a camera that images a subject person, the image apparatus comprising:
a smoked glass arranged in front of an image lens of the camera accommodated in the body, and
a dummy lens arranged in the periphery of the image lens and in a position that can be viewed by the subject person.

2. An image apparatus accommodated in a body and provided with a camera that images a subject person, the image apparatus comprising:
a shielding member arranged in front of an image lens of the camera accommodated in the body, and
a dummy lens arranged in the periphery of the image lens and in a position that can be seen by the subject person.

3. A face authentication apparatus including:
storage means that stores a respective face picture of a plurality of registrants,
a camera that is accommodated in a body and images a face of a subject person, and
authentication means that processes a face picture, imaged by the camera, of the subject person and authenticates whether the subject person is a registrant, whose face picture is stored in the storage means, the face authentication apparatus comprising
a shielding member arranged in front of an image lens of the camera accommodated in the body, and
a dummy lens arranged below the image lens and in a position that can be seen by the subject person.

4. An image apparatus according to claim 2, wherein the shielding member comprises a color filter.

5. An image apparatus according to claim 2, wherein the shielding member comprises smoked glass.

6. An image apparatus according to claim 3, wherein the shielding member comprises a color filter.

7. An image apparatus according to claim 3, wherein the shielding member comprises smoked glass.

8. A method of manufacturing an authenticating apparatus comprising:
arranging an imaging lens to obtain an image of a subject to be authenticated;
disposing a shielding member over the imaging lens; and
positioning a dummy lens in a periphery of the imaging lens.

9. A method of manufacturing according to claim 8, wherein the dummy lens is positioned below the imaging lens.

10. A method of manufacturing according to claim 8, wherein the shielding member is one of smoked glass or a color filter.

11. A method of controlling access comprising:
storing reference image data;
obtaining subject image data using a camera having an imaging lens shielded from view by the subject and a dummy lens visible to the subject in the periphery of the imaging lens; and
controlling access based on a degree of similarity between the subject image data and respective reference image data.

12. A method of controlling access according to claim 11, wherein the subject is a person, and the subject image data is obtained with the subject looking downward toward the dummy lens.

13. A method according to claim 12, wherein the image obtained is of a part of the person's face.

14. A method of obtaining an image of a subject for authentication comprising:
arranging a camera having an imaging lens to obtain an image of a subject to be authenticated;
disposing a shielding member over the imaging lens such that the imaging lens is difficult for the subject to view;
positioning a dummy lens in a periphery of the imaging lens so as to be in view of the subject; and
obtaining an image of the subject using the camera.

15. A method according to claim 14, wherein the imaging lens is shielded from view of the subject.

16. A method according to claim 14, wherein the subject is a person, and the image obtained is of a part of the person's face.
